(19) United States
(12) Patent Application Publication
(10) Pub. No.: US 2023/0077332 A1
(43) Pub. Date: Mar. 16, 2023

(54) Defect Inspection System and Defect Inspection Method

(71) Applicant: Hitachi High-Tech Corporation, Tokyo (JP)

(72) Inventors: Yuko SANO, Tokyo (JP); Masayoshi ISHIKAWA, Tokyo (JP); Hiroyuki SHINDO, Tokyo (JP)

(21) Appl. No.: 17/895,264

(22) Filed: Aug. 25, 2022

(30) Foreign Application Priority Data
Sep. 15, 2021 (JP) 2021-150035

(51) Int. Cl. G06T 7/00; G01N 21/95; G06T 7/70; G06V 10/764; G06V 10/22; G06V 10/774; G06V 10/82

(52) U.S. Cl. CPC G06T 7/0008; G01N 21/9501; G06T 7/001; G06T 7/70; G06V 10/22; G06V 10/82; G06V 10/764; G06V 10/774; G06T 2207/10061; G06T 2207/20081; G06T 2207/20084; G06T 2207/30148

(57) ABSTRACT

A defect inspection system includes: a defect detection unit that detects defect positions in an inspection image by comparing an inspection image with a reference image that is an image having no defect; a filter model that classifies detected defect positions into false defect or a designated type of defect; a filter condition holding unit that holds a filter condition; a defect region extraction unit that collects the defect positions detected by the defect detection unit for each predetermined distance; a defect filter unit that determines whether or not each defect region satisfies the filter condition and extracts only the defect region that satisfies the filter condition; and a normalization unit that normalizes the inspection image based on a processing step at the time of inspection and a normalization condition set for each processing step or each imaging condition.

### CLAIM OF PRIORITY

The present application claims priority from Japanese Patent Application Serial No.2021-150035, filed on Sep. 15, 2021, the content of which is hereby incorporated by reference into this application.

### BACKGROUND OF INVENTION

### 1. Field of the Invention

The present invention relates to a defect inspection system and a defect inspection method using an inspection image of a sample acquired by an electron microscope.

### 2. Description of the Related Art

In a semiconductor inspection, an SEM image captured by a critical dimension-SEM (CD-SEM) or the like that is a modification of a scanning electron microscope (SEM) is used. As a conventional semiconductor inspection method, there has been known a reference image comparison inspection. In this method, a reference image that capture the same semiconductor circuit shape as that of an inspection target but is captured at a point different from a point where the inspection image is captured and the inspection image are compared with each other, and the presence or absence of a defect is determined based on difference of pixel values between the reference image and the inspection image. In this inspection, it is necessary to increase the detection sensitivity in order to detect a minute defect. However, when the detection sensitivity is increased, erroneous detection called false defect increases. Accordingly, there exists a problem that it is difficult to adjust the detection sensitivity. Further, with respect to types of defects of a semiconductor, a plurality of types of defects exist. However, it is difficult to control a type of detected defect based on the detection sensitivity adjustment in a reference image comparison inspection.

In order to solve these problems, a learning model for removing false defect from a detection result of a reference image comparison inspection has been studied. As this conventional technique, for example, Japanese Patent Application Laid-Open No. 2018 -120300 discloses a technique capable of realizing a defect determination method with sufficient inspection accuracy by extracting a periphery of a defect region and by classifying a real defect and false defect. Specifically, Japanese Patent Application Laid-Open No. 2018 -120300 discloses an information processing apparatus that includes: a first learning unit that trains a first model for discriminating normal data by using a set of the normal data;
a second learning unit that trains a second model for identifying correct data and incorrect data by using an anomaly candidate region selected by a user as the correct data and an anomaly candidate region not selected by the user as the incorrect data among a plurality of anomaly candidate regions indicating an anomaly candidate region detected based on the first model from each of a plurality of captured images prepared in advance; an acquisition unit that acquires the captured image:
a detection unit that detects the anomaly candidate region from the captured image acquired by the acquisition unit by using the first model, a determination unit that determines whether the anomaly candidate region detected by the detection unit using the second model belongs to the correct data or the incorrect data; and an output control unit that performs a control of outputting a determination result made by the determination unit.

### SUMMARY OF THE INVENTION

In the detection of defects in semiconductor inspection, a type of defect to be extracted differs for each inspection target step and hence, it is required to apply filtering to a defect detection result for each step. However, in the technique disclosed in Japanese Patent Application Laid-Open No. 2018 -120300, a model for filtering is trained for each step. Accordingly, it takes time to collect data and to perform learning. Furthermore, in a case where an inspection image differs due to difference in imaging conditions, there may arise a problem that a model is to be retrained.

Accordingly, it is an object of the present invention to provide a defect inspection system and a defect inspection method that enable highly efficient inspection by absorbing a difference in inspection images due to a difference in imaging conditions or having a filter model that can be commonly used in respective inspection steps.

To overcome the above-mentioned drawbacks, a defect inspection system according to the present invention is a defect inspection system that inspects presence or absence of a defect in a sample to be processed in one or more processing steps based on an inspection image of the sample captured after the one or more processing steps, the defect inspection system including: a defect detection unit configured to detect defect positions in the inspection image by comparing the inspection image with a reference image that is an image having no defects at the same inspection point as an inspection point of the inspection image;
a filter model configured to classify the defect positions detected by the defect detection unit into false defect or a designated type of defect;
a filter condition holding unit configured to hold a filter condition formed of the designated type of defect and/or a size of defect; a defect region extraction unit configured to extract a defect region where the defect positions detected by the defect detection unit are collected for each predetermined distance;
a defect filter unit configured to determine whether or not each defect region extracted by the defect region extraction unit satisfies the filter condition, and configured to extract only the defect region that satisfies the filter condition; and a normalization unit configured to normalize the inspection image based on the processing step and a normalization condition set for each processing step or each imaging condition at the time of inspection, in which the filter model is configured to be acquired by training using the inspection image normalized by the normalization unit.

A defect inspection method according to the present invention is a defect inspection method for inspecting presence or absence of a defect in a sample to be processed in one or more processing steps based on an inspection image of the sample captured after the one or more processing steps, in which a defect detection unit detects defect positions in the inspection image by comparing the inspection image with a reference image that is an image having no defects at the same inspection point as an inspection point of the inspection image; a filter model classifies the defect detected by the defect detection unit into false defect or a designated type of defect; a filter condition holding unit holds a filter condition formed of the designated type of defect and/or a size of defect; a defect region extraction unit extracts only the defect region where the defect positions detected by the defect detection unit are collected for each predetermined distance;

a defect filter unit determines whether or not each defect region extracted by the defect region extraction unit satisfies the filter condition, and extracts only the defect region that satisfies the filter condition; and a normalization unit normalizes the inspection image based on the processing step and a normalization condition set for each processing step or each imaging condition at the time of inspection, and the filter model is acquired by training using the inspection image normalized by the normalization unit.

According to the present invention, it is possible to provide the defect inspection system and the defect inspection method that enable highly efficient inspection by absorbing a difference in inspection image due to a difference in imaging condition or have a filter model that can be commonly used in respective inspection steps.

For example, it is possible to separate a real defect and false defect using a common filter model in respective inspection steps by absorbing the difference in inspection image due to the difference in imaging condition. Furthermore, it is possible to output only a type of defect and a size of defect to be extracted for each step.

Problems, configurations, and advantageous effects other than those described above will be clarified by the following description of embodiments.

### BRIEF DESCRIPTION OF THE DRAWINGS

FIG. 1 is a functional block diagram illustrating the overall configuration of a defect inspection system according to a first embodiment that is an embodiment of the present invention;

FIG. 2 is a block diagram of main functional units at the time of training by a data processing unit that forms the defect inspection system illustrated in FIG. 1;

FIG. 3 is a flowchart at the time of training by the defect inspection system illustrated in FIG. 1;

FIG. 4 is a block diagram of main functional units at the time of performing inference by the data processing unit that forms the defect inspection system illustrated in FIG. 1;

FIG. 5 is a flowchart at the time of performing inference by the defect inspection system illustrated in FIG. 1;

FIG. 6 is a detailed diagram of a specific defect inspection flow in the first embodiment;

FIG. 7 is a view illustrating an operation of a defect filter unit according to the first embodiment;

FIG. 8 is a flowchart of the defect filter unit according to the first embodiment;

FIG. 9 is a flow chart of an inspection image normalization unit according to the first embodiment;

FIG. 10 is a table illustrating an advantageous effect of an inspection image normalization unit according to the first embodiment;

FIG. 11 is a view illustrating a learning GUI according to the first embodiment;

FIG. 12 is a view illustrating an inference GUI according to the first embodiment;

FIG. 13 is a flowchart at the time of training by a defect inspection system according to a second embodiment that is another embodiment of the present invention; and

FIG. 14 is a detailed view of a conventional specific defect inspection flow.

### DESCRIPTION OF THE PREFERRED EMBODIMENTS

Hereinafter, embodiments of the present invention will be described with reference to the drawings. In all the drawings for describing the present invention, constituent elements having the same functions are denoted by the same reference numerals, and repeated description of the constituent elements may be omitted.

### First Embodiment

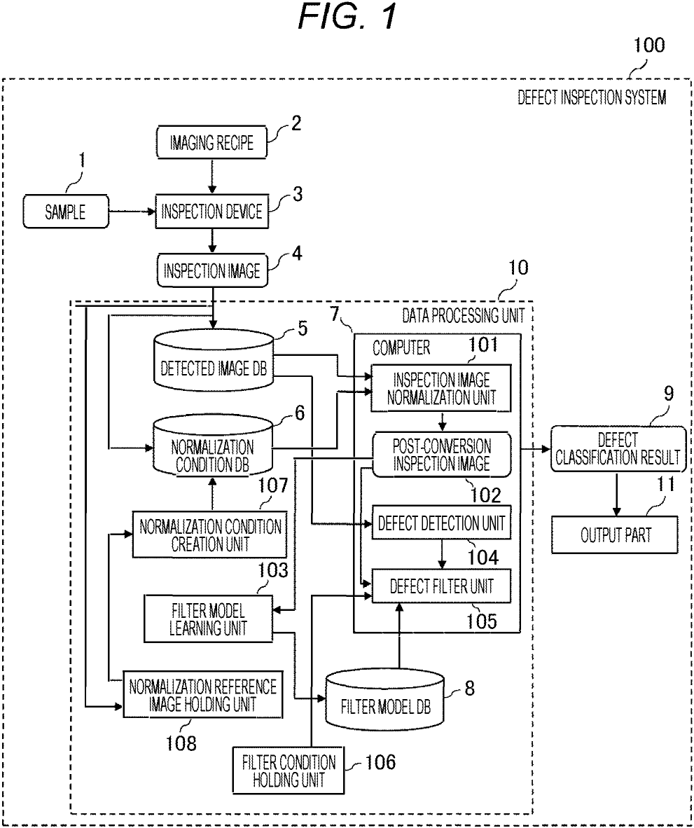

FIG. 1 is a functional block diagram illustrating the overall configuration of a defect inspection system according to the first embodiment that is one embodiment of the present invention; As illustrated in FIG. 1, the defect inspection system 100 includes a sample 1, an imaging recipe 2, an inspection device 3, an inspection image 4, a data processing unit 10, and an output unit 11 that outputs a defect classification result 9. The sample 1 (for example, a semiconductor wafer) is inputted into the inspection device 3, and the inspection image 4 is acquired in accordance with the imaging recipe 2. The acquired inspection image 4 is inputted to the data processing unit 10. The inspection device 3 is, for example, a critical dimension-SEM (CD-SEM) or an inspection SEM that is a modification of a scanning electron microscope (SEM) is used.

The data processing unit 10 includes an inspection image DB 5, a normalization condition DB 6, a computer 7, a filter model DB 8, a filter model learning unit 103, a filter condition holding unit 106, a normalization condition creation unit 107, and a normalization normalized image holding unit 108. The computer 7 also includes an inspection image normalization unit 101, a post-conversion inspection image 102, a defect detection unit 104, and a defect filter unit 105. In such a configuration, the filter model learning unit 103, the normalization condition creation unit 107, the inspection image normalization unit 101, the defect detection unit 104, and the defect filter unit 105 are realized by, for example, a processor such as a CPU (not illustrated), a ROM that stores various programs, a RAM that temporarily enables storing of data in an arithmetic operation processing, and a storage device such as an external storage device. The processor such as a CPU reads and executes the various programs stored in the ROM, and stores an arithmetic operation result that is a result of the execution in the RAM or the external storage device.

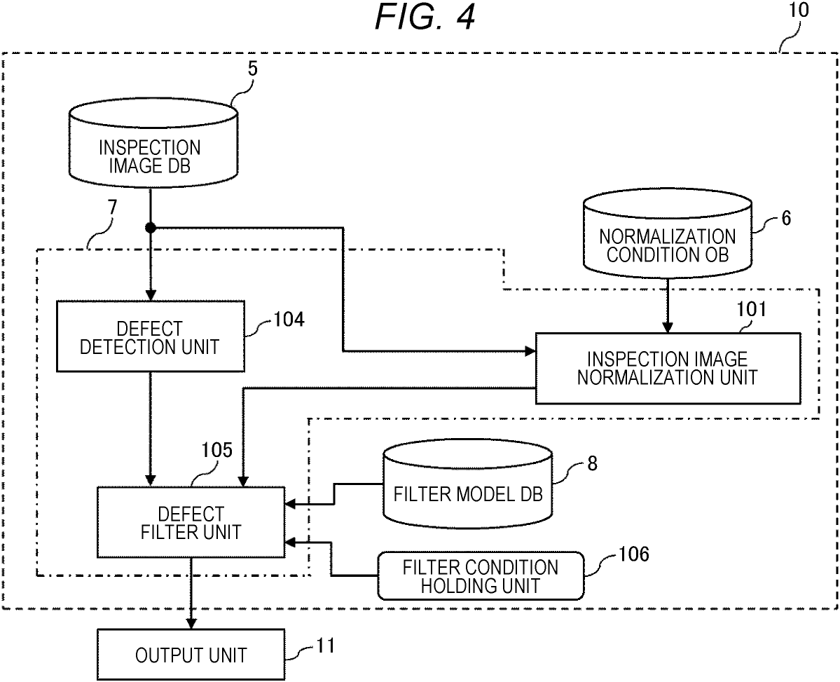

The inspection image 4 acquired for each processing step is held in the inspection image DB 5. The inspection image DB 5 also includes a reference image that is a defect-free image having the same semiconductor circuit shape as that of the inspection image and captured at a point different from the position of the inspection image. The normalization condition creation unit 107 computes a conversion parameter for converting the inspection image 4 for each processing step into a normalized image to be used by the computer 7, and the conversion parameter is held in the normalization condition DB 6. The defect detection unit 104 that forms the computer 7 detects a defect present in the inspection image. The defect filter unit 105 that forms the computer 7 removes false defect where a normal portion contained in the detection result of the defect detection unit 104 is erroneously detected as a defect, and further identifies a size of defect and a type of defect. Details of the above-mentioned configuration will be described with reference to FIG. 4. The computer 7 identifies the false defect, the size of defect, and the type of defect contained in the inspection image 4 using an inspection image held in the inspection image DB 5, conversion parameters held in the normalization condition DB 6, and a filter model for classifying the type of defect held in the filter model DB 8. The computer 7 outputs a defect classification result 9 to the output unit 11. Accordingly, when the inspection image 4 of the sample 1 is inputted into the data processing unit 10, it is possible to identify false defect, the size of defect and the type of defect contained in the inspection image 4. It must be noted that the output unit 11 is realized by, for example, a display such as a liquid crystal display (LCD) or an electro luminescence (EL) (not illustrated). Furthermore, the output unit 11 receives not only a display on a touch panel or the like but also inputting by a user. The output unit 11 functions as a so-called input/output device graphical user interface (GUI).

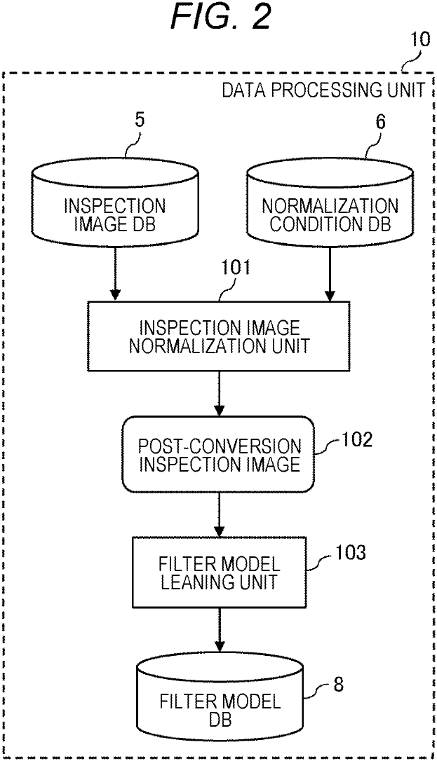

FIG. 2 is a block diagram of main functional units at the time of training by a data processing unit that forms the defect inspection system illustrated in FIG. 1. As illustrated in FIG. 2, the data processing unit 10 that forms the defect inspection system 100 includes an inspection image DB 5, a normalization condition DB 6, an inspection image normalization unit 101, a filter model learning unit 103, and a filter model DB 8. First, the inspection image normalization unit 101 takes out a learning data set of an inspection image in a processing step that is an inspection target stored in the inspection image DB 5. At the same time, the inspection image normalization unit 101 takes out a conversion parameter for converting the inspection image in the target processing step stored in the normalization condition DB 6 into the normalized image. In this embodiment, the conversion parameters stored in the normalization condition DB 6 need to be prepared before training a filter model (also referred to as a classification model). Accordingly, for example, in a case where an inspection image that is used in the first defect inspection is set as a normalized image, at a point of time that an inspection image that is used in the second and subsequent defect inspections is obtained, a conversion parameter for converting the second inspection image into the first inspection image is computed and is stored in the normalization condition DB 6. In this case, the above-mentioned normalization normalized image holding unit 108 illustrated in FIG. 1 holds the inspection image used in the first defect inspection as the normalized image. The normalization condition creation unit 107 reads the inspection image to be used in the first defect inspection that is held in the normalization normalized image holding unit 108, and calculates a conversion parameter for converting the second inspection image into the first inspection image. Alternatively, the normalized image is determined in advance, and at a point of time that the inspection image is obtained, a conversion parameter for converting the inspection image that is held in the normalization normalized image holding unit 108 into the normalized image determined in advance by the normalization condition creation unit 107 is calculated, and the inspection image is stored in the normalization condition DB 6. In this embodiment, the normalized image means an image serving as a reference for normalization. The data set of the extracted inspection image and the conversion parameter are inputted into the inspection image normalization unit 101. The inspection image normalization unit 101 adopts affine transformation, for example, and converts the inspection image into a normalized image using the following Expression (1).

$$A = m i n \vert \vert {I}_{b a s e} - {f}_{i} ( {I}_{i} ) \vert \vert {}^{2}$$

In Expression (1), that is, in fᵢ (lᵢ) = aᵢlᵢ + bᵢ, aᵢ and bᵢ are conversion parameters in the coordinates i on the image. When aᵢ < 0, the inversion of pixels is possible. Expression (1) changes a luminance value at an arbitrary coordinate on an image linearly so that the difference between this luminance with a luminance value Ibase of a normalized image is minimized. By applying this conversion expression, even with respect to inspection images that differ in processing steps, the luminance of the inspection image on the same coordinate can be converted into the same luminance value as the reference. This inspection image becomes the post-conversion inspection image 102. The post-conversion inspection image 102 (also referred to as a normalized inspection image) is a common inspection image regardless of the processing steps and hence, it is not necessary to have a filter model for each processing step, and it is sufficient to have a common filter model for all processing steps. The filter model learning unit 103 performs, for example, convolution neural network (CNN) such as Unet. The filter model trained by the filter model learning unit 103 is stored in the filter model DB 8.

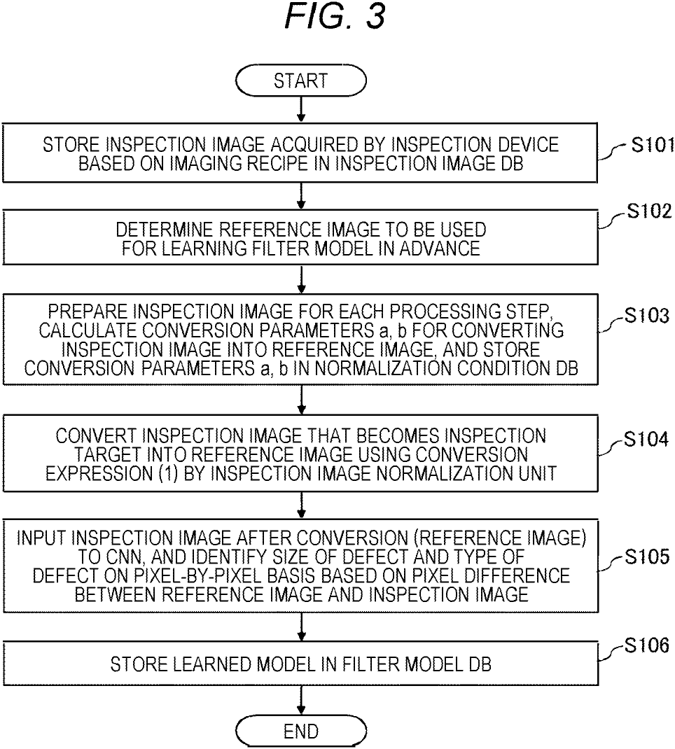

FIG. 3 is a flowchart at the time of training by the defect inspection system 100 illustrated in FIG. 1. First, in step S101, an inspection image 4 acquired by the inspection device 3 is stored in the inspection image DB 5 based on the imaging recipe 2. Next, in step S102, a normalized image to be used for training a filter model is determined in advance. Thereafter, in step S103, the normalization condition creation unit 107 creates a data set of an inspection image for each processing step, calculates the conversion parameters aᵢ and bᵢ for converting the inspection image into a normalized image, and stores the conversion parameters aᵢ and bᵢ in the normalization condition DB 6. Then, in step S104, the inspection image normalization unit 101 converts the inspection image that becomes an inspection target into the normalized image using Conversion Expression (1). Thereafter, in step S105, the post-conversion inspection image (normalized image) 102 is inputted to a CNN, that forms the filter model learning unit 103, and false defect, a size of defect, and a type of defect are identified on a pixel-by-pixel basis based on a pixel difference between the reference image and the inspection image. Specifically, in the identification of false defect, a size of defect and a type of defect, a probability (degree of certainty) that the defect is an actual defect and a degree of certainty that the type of defect is, for example, a defect of “short wiring” are calculated for each pixel. In such processing, as the teacher information used at the time of training, for example, a defect detection result that exists in a bounding box surrounding a defect site by manual annotation is set as an actual defect, and a defect detection result that exists outside the bounding box is set as false defect. Further, a type of defect and a size of defect are also set as teacher information at the time of annotation. In addition, not only supervised learning but also unsupervised learning may be used. Finally, in step S106, a trained filter model is stored in the filter model DB 8. As a result, false defect, a size of defect, and a type of defect can be identified using a common filter model in a plurality of processing steps. This is because the filter model (classification model) can be made common between steps where the same pattern exists.

FIG. 4 is a block diagram of main functional units at the time of performing inference by the data processing unit that forms the defect inspection system illustrated in FIG. 1. As illustrated in FIG. 4, a data processing unit 10 that forms the defect inspection system 100 includes the defect detection unit 104, the defect filter unit 105, the normalization condition DB 6, the inspection image normalization unit 101, the filter model DB 8, and the filter condition holding unit 106. The computer 7 is formed of the defect detection unit 104, the defect filter unit 105, and the inspection image normalization unit 101. First, the inspection image normalization unit 101 takes out an inference data set of an inspection image in a processing step that is an inspection target stored in the inspection image DB 5. Conversion parameters of the inspection image in the processing step of the inspection target are taken from the normalization condition DB 6, and the conversion parameters are inputted to the inspection image normalization unit 101 together with the inference data set. The inspection image normalization unit 101 converts the inspection image into a normalized image that can be used in the filter model. The defect detection unit 104 executes, for example, a die-to-die (D2D) inspection where an inspection image and a reference image are compared to each other and the pixel difference is detected as a defect or a die-to-database (D2DB) inspection where an inspection image and a design drawing are compared to each other and detects a defect. Therefore, the defect detection unit 104 uses the inspection image as an input, and outputs, for example, an image where 1 is given to a defect portion and 0 is given to portions other than the defect portion to the defect filter unit 105 as a defect detection result. The defect detection result outputted from the defect detection unit 104 and a normalized image outputted from the inspection image normalization unit 101 are inputted to the defect filter unit 105, and false defect, the size of defect, and the type of defect are specified on a pixel-by-pixel basis using a trained filter model read from the filter model DB 8. Thereafter, only a degree of certainty, a size of defect, and/or a type of defect designated under filter conditions held in the filter condition holding unit 106 are filtered, and a result of filtering is outputted from the output unit 11. The filter condition held in the filter condition holding unit 106 is designated by a size of defect and a type of defect. The types of the defect include, for example, a short wiring pattern, a short circuit in the wiring pattern (a state where wires that are originally to be connected are disconnected), a tapered wiring pattern, an open wiring pattern (a state where wires that are originally to be separated from each other are connected to each other), a flaw on the wiring pattern, a foreign matter on the wiring pattern or outside the wiring pattern, a defect in a portion other than the wiring pattern, a contrast, and the like. The size of defect and the type of defect desired to be finally outputted are different depending on a sample processing step. Accordingly, it is necessary to extract only the defect necessary for each processing step based on a filter condition held in the filter condition holding unit 106.

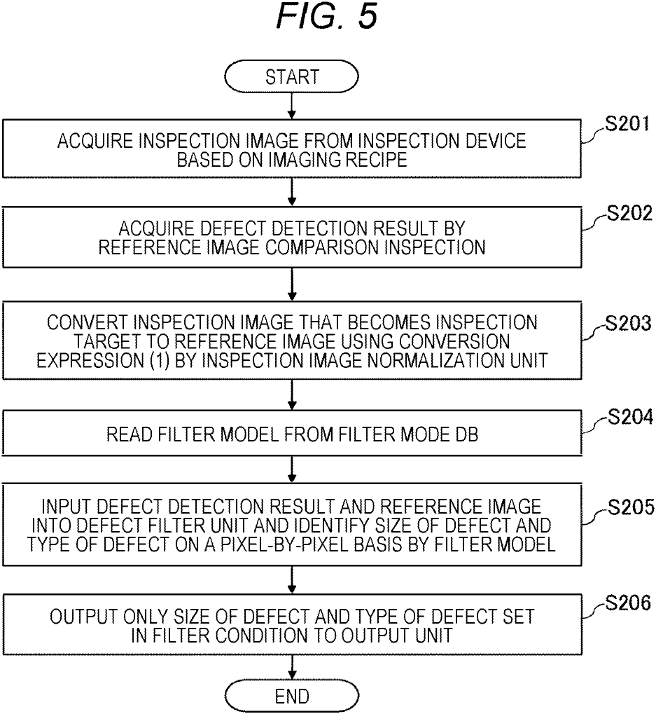

FIG. 5 is a flowchart at the time of performing inference by the defect inspection system 100 illustrated in FIG. 1. First, in step S201, an inspection image is acquired by the inspection device 3 based on the imaging recipe 2. Next, in step S202, the defect detection unit 104 acquires a defect detection result by performing a reference image comparison inspection. Then, in step S203, the inspection image normalization unit 101 converts the inspection image that becomes an inspection target into a normalized image (an image that becomes a reference in normalization) using the above-mentioned Conversion Expression (1). Then, in step S204, the defect filter unit 105 reads a trained filter model from the filter model DB 8. In step S205, the defect detection result outputted from the defect detection unit 104 and the normalized image are inputted to the defect filter unit 105, and false defect, a size of defect, and a type of defect are identified on a pixel-by-pixel basis using the trained filter model (classification model) that has been read. Finally, in step S206, the defect filter unit 105 outputs only a size of defect, and/or a type of defect set under filter conditions held by the filter condition holding unit 106 to the output unit 11. As a result, even in the defect inspection in a processing step different from a processing step performed previous time, it is possible to identify false defect, a size of defect, and a type of defect using an existing filter model without training a filter model. Further, in the inspection in a processing step where a defect is hardly detected, false defect, a size of defect, and a type of defect can be identified using an existing filter model without training a filter model by collecting learning data. In the above-mentioned processing, the inspection in a processing step where a defect is hardly detected means a case where the number of defects is small so that the collection of learning data is difficult.

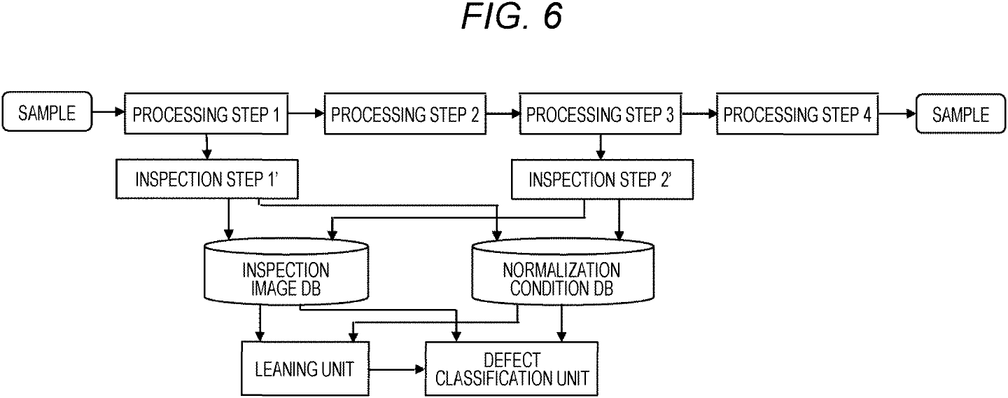

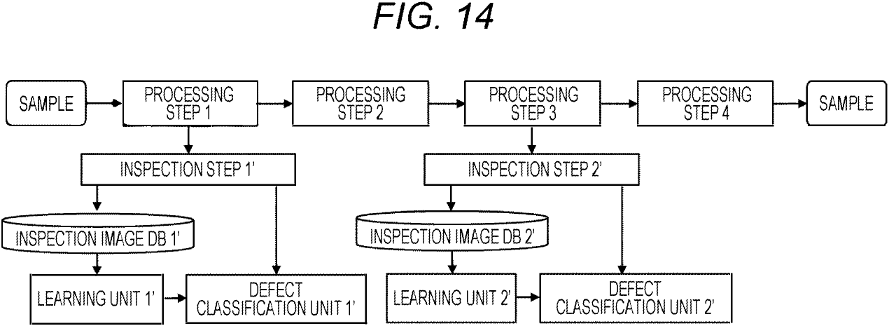

FIG. 6 is a detailed diagram of a specific defect inspection flow according to this embodiment. As illustrated in FIG. 6, a case is considered where a sample is completed through processing step 1, processing step 2, processing step 3, and processing step. When classifying defects in the processing step 1 and the processing step 3, it has been conventionally necessary that a learning unit and a defect classification unit are required for each processing step (see FIG. 14). However, as illustrated in FIG. 6, an inspection image DB and a normalization condition DB are provided, and the inspection image in the processing step 1 and the inspection image in the processing step 3 are stored in an inspection image DB, and conversion parameters for converting the inspection image in the processing step 1 and the inspection image in the processing step 3 into normalized image are stored in the normalization condition DB. Accordingly, the inspection image in the processing step 1 and the inspection image in the processing step 3 can be converted into the same normalized image. Therefore, the learning unit and the defect classification unit can be shared in common by the respective processing steps. Further, this embodiment also has an advantageous effect that a filter model can be trained using an inspection image where a defect is likely to occur, and the inspection of another processing step where a defect hardly occurs can be performed using a trained filter model.

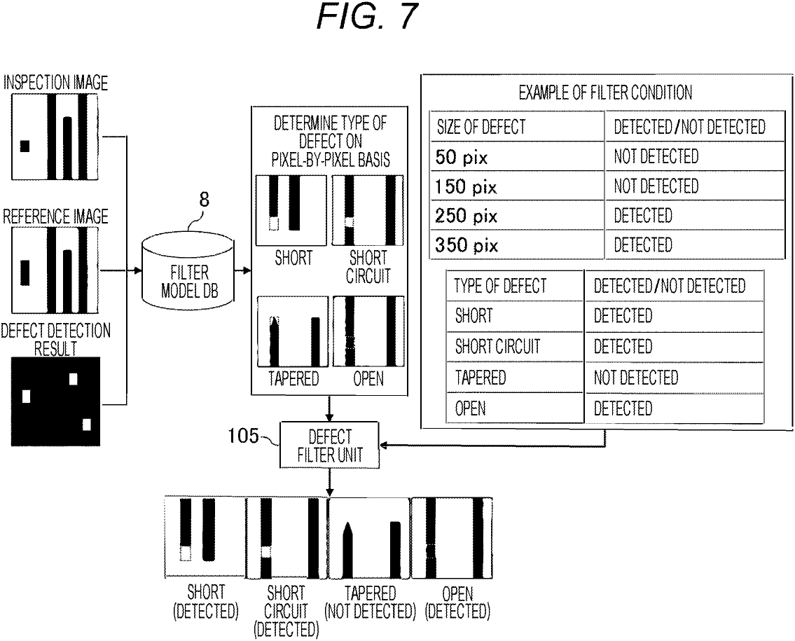

FIG. 7 is a view illustrating an operation of a defect filter unit according to this embodiment. When an inspection image, a reference image, and a defect detection result are inputted to the filter model stored in the filter model DB 8, the defect filter unit 105 determines a size of defect, a type of defect on a pixel-by-pixel basis. FIG. 7 illustrates, as an example, a case where the type of defect is classified into four patterns consisting of a short wiring pattern, a shortcircuited wiring pattern, a tapered wiring pattern, and an open wiring pattern. Thereafter, when the filter condition holding unit 106 sets the filter condition based on the filter conditions held by the filter condition holding unit 106, such that, for example, only three types of defects consisting of the defect having the size of 250 pix or more, the type of defect having the short wiring pattern, the type of defect having the short-circuit pattern, and the type of defect having the open wiring pattern are detected, and the classification result based on the filter model and the filter condition are inputted to the defect filter unit 105, eventually, only three types of defects other than the type of defect that wiring pattern is tapered can be outputted. Among the types of defects in the filter condition, the defect having the tapered wiring pattern is not detected. This means that it is unnecessary to perform the detection with respect to the defect having the tapered wiring pattern.

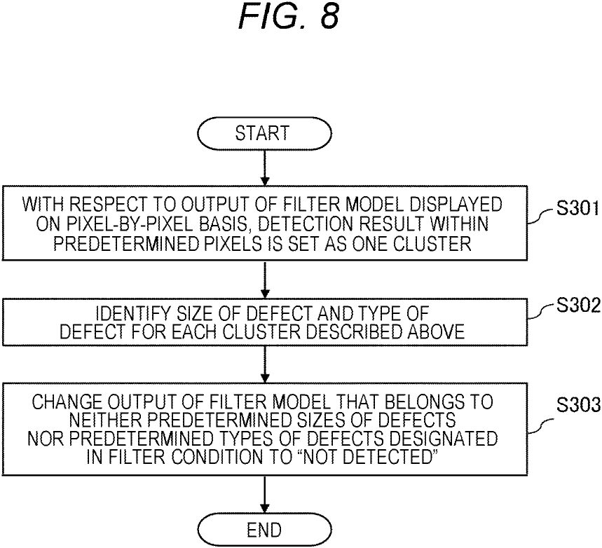

FIG. 8 is a flowchart of the defect filter unit 105 according to this embodiment. First, in step S301, with respect to an output of the filter model displayed on a pixel-by-pixel basis, a detection result within predetermined pixels is set as one cluster. In this processing, with respect to one cluster, a continuous region (connected region) formed of respective pixels where information contained in each pixel is other than 0 is defined as one cluster. Then, in step S302, a size of defect and a type of defect are identified for each cluster created in step S301. Finally, in step S303, an output of the filter model that belongs to neither the predetermined sizes of defects nor types of defects indicated in the filter condition 106 held by the filter condition holding unit 106 is changed to no detection. As a result, it is possible to extract only the sizes of the defects and the types of defects necessary in arbitrary processing steps.

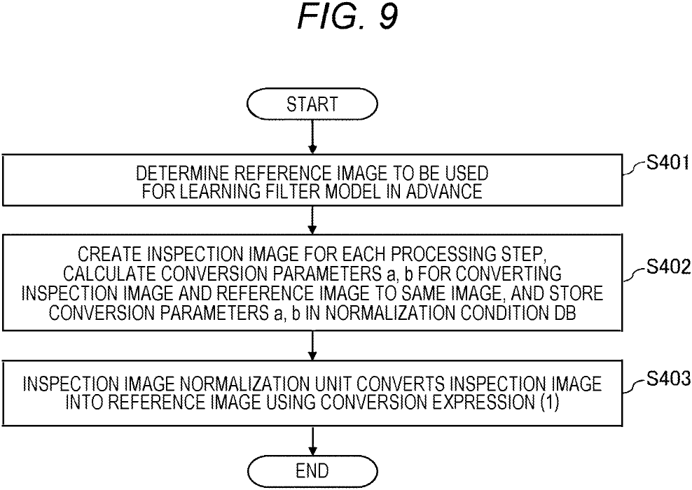

FIG. 9 is a flowchart of an inspection image normalization unit 101 according to this embodiment. First, in step S401, a normalized image to be used in training a filter model is determined in advance. Next, in step S402, the inspection image normalization unit 101 creates an inspection image for each processing step, calculates conversion parameters aᵢ and bᵢ for converting the inspection image and a normalized image into the same image, and stores the conversion parameters aᵢ and bᵢ in the normalization condition DB 6. Finally, in step S403, the step inspection image normalization unit 101 converts the inspection image into the normalized image using the above-mentioned Conversion Expression (1). As a result, inspection images having different processing steps can be converted into normalized image that can be used in a common filter model in all processing steps.

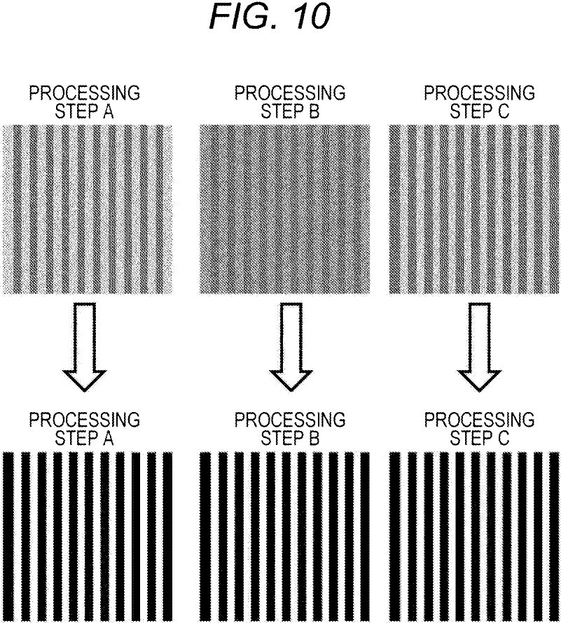

FIG. 10 is a diagram illustrating an example of an advantageous effect of the inspection image normalization unit 101 according to the present embodiment. As illustrated in FIG. 10, a case is considered where the inspection image normalization unit 101 has a processing step A, a processing step B, and a processing step C where although the respective inspection images have the same wiring pattern, but the respective inspection images have different colors. In this processing, the processing step A and the processing step B, the processing step C mean, for example, an etching step, a lithography step, or the like. When the inspection image normalization unit 101 converts three respective inspection images using the above-mentioned Conversion Expression (1), all three inspection images become the same normalized image. As a result, even in a case where the processing steps are different from each other, the types of defects can be classified using the same filter model.

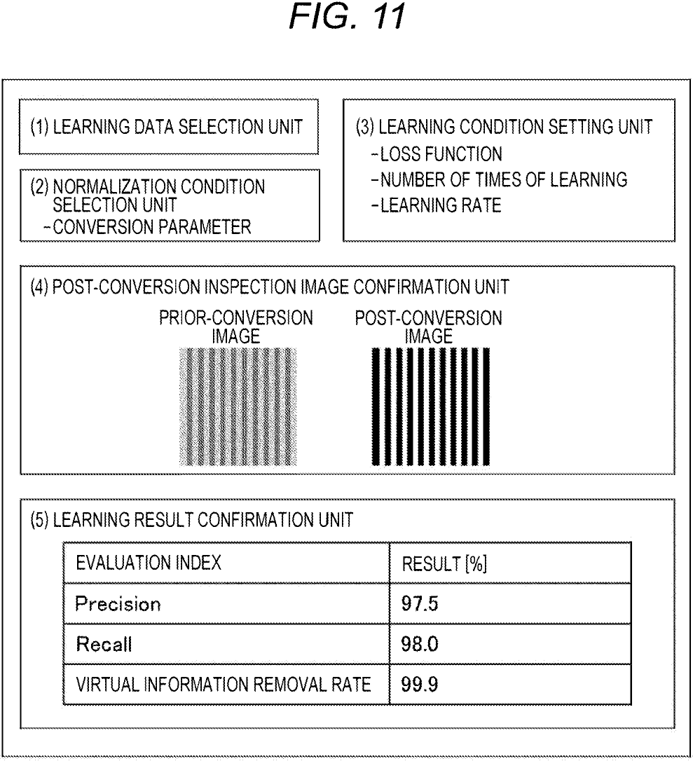

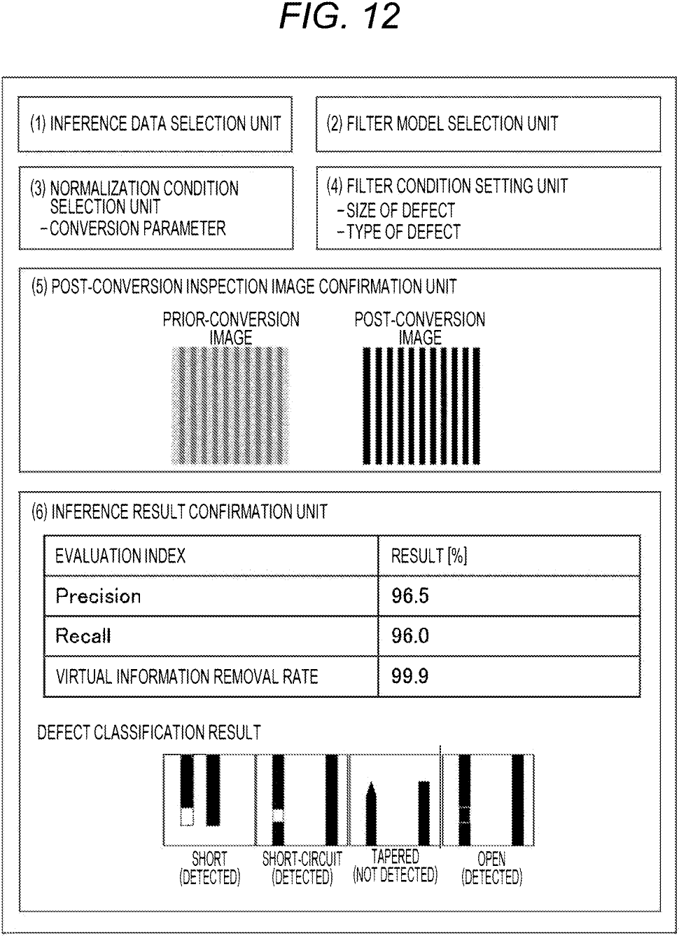

A specific example of an input/output device graphical user interface (GUI) used in a control of the defect inspection system 100 will be described with reference to FIG. 11 and FIG. 12. It must be noted that, as described above, the input/output device GUI corresponds to, for example, the output unit 11 illustrated in FIG. 1. FIG. 11 is a diagram illustrating a learning GUI. In the learning GUI, (1) a learning data selection unit, (2) a normalization condition selection unit, (3) a learning condition setting unit, (4) a post-conversion inspection image confirmation unit, (5) a learning result confirmation unit, and the like are set. (1) The learning data selection unit selects an inspection image in a processing step that becomes a target for a defect inspection. (2) The normalization condition selection unit selects a conversion parameter aᵢ, b for converting the inspection image selected in (1) into a normalized image. (3) In the learning condition setting unit, the number of losses, the number of times of learnings, a learning rate, and the like are set. Under such conditions, the inspection image is first converted into a normalized image, and the result of the conversion is outputted to (4) the post-conversion inspection image confirmation unit. A filter model is learned using the outputted normalized image, and the learning result is outputted to the (5) learning result confirmation unit. The outputted learning result is confirmed. When none of precision (detection accuracy), recall (defect detection rate), and a false defect removal rate, that are evaluation indexes, reaches the target values, the learning condition is set again by the (3) the learning condition setting unit, and the filter model is trained.

FIG. 12 is a diagram illustrating an inference GUI. In the inference GUI, (1) an inference data selection unit, (2) a filter model selection unit, (3) a normalization condition selection unit, (4) a filter condition setting unit, (5) a post-conversion inspection image confirmation unit, (6) an inference result confirmation unit and the like are set. (1) The inference data selection unit selects an inspection image in a processing step that becomes a target for a defect inspection. (2) The filter model selection unit selects a filter model that can be used in processing steps for an inspection target. (3) The normalization condition selection unit selects, in the same manner as the learning GUI, a conversion parameter aᵢ, bᵢ for converting the inspection image selected in (1) into a normalized image. (4) The filter condition setting unit sets a size of defect and a type of defect to be extracted in processing steps for the inspection target. The result of the conversion from the inspection image to the normalized image is outputted to (5) the post-conversion inspection image confirmation unit. The outputted normalized image is inferred by a filter model designated by (2) the filter model selection unit, and the type of defect is classified on a cluster-by-cluster basis within predetermined pixels. Thereafter, based on the conditions set by the (4) the filter condition setting unit, only the defects to be extracted are outputted for each processing step. These inference results are outputted to the (6) inference result confirmation unit.

As described above, according to this embodiment, it is possible to provide the defect inspection system and the defect inspection method that enable highly efficient inspection by having the filter model that can be commonly used in the respective inspection steps.

Specifically, by converting the inspection images having different processing steps into the common normalized image, it is unnecessary to have a filter model for each processing step, and the common filter model can be used in all processing steps and hence, the inspection time can be shortened. In addition, the number of filter models to be managed is reduced and hence, it is possible to acquire an advantageous effect that management is also facilitated. Furthermore, not only false defect contained in the defect detection result can be removed, but also a size of defect and a type of defect can be specified for each processing step. Further, in the inspection in processing step where a defect is hardly detected, false defect, a size of defect, and a type of defect can be identified using an existing filter model without collecting learning data and training a filter model.

### Second Embodiment

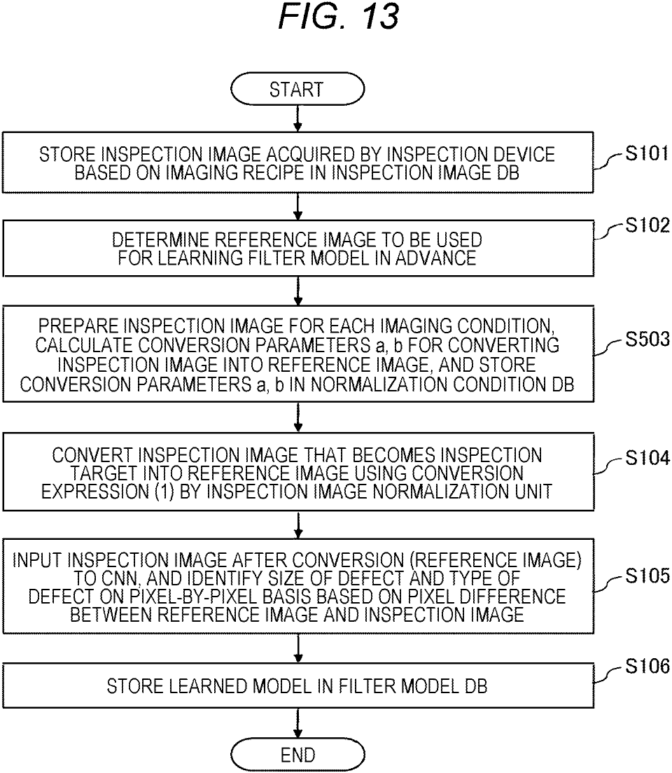

FIG. 13 is a flowchart at the time of training using a defect inspection system according to a second embodiment that is another embodiment of the present invention. In the above-mentioned first embodiment, an inspection image is created for each processing step. This embodiment is different from the first embodiment in that an inspection image is created for each imaging condition. The configuration itself of the defect inspection system according to this embodiment is substantially equal to the corresponding configuration of the defect inspection system in the functional block diagrams illustrated in FIG. 1, FIG. 2 and FIG. 4 in the first embodiment. Accordingly, constituent parts of this embodiment corresponding to the constituent parts in the first embodiment are omitted in the description made hereinafter.

This embodiment focuses on the point that a deformation amount, an image quality and a contrast change due to a change in an imaging condition. The point that an optimum imaging condition is also changeable for each processing step is also considered.

First, as illustrated in FIG. 13, in step S101, the inspection image 4 acquired by the inspection device 3 is stored in the inspection image DB 5 based on the imaging recipe 2. Next, in step S102, a normalized image to be used for training a filter model is determined in advance. Thereafter, in step S503, the normalization condition creation unit 107 creates a data set of an inspection image for each imaging condition, calculates conversion parameters aᵢ and bᵢ for converting the inspection image into a normalized image, and stores the conversion parameters aᵢ and bᵢ in the normalization condition DB 6. Then, in step S104, the inspection image normalization unit 101 converts the inspection image that becomes an inspection target into the normalized image using Conversion Expression (1) described above. Thereafter, in step S105, the post-conversion inspection image (normalized image) 102 is inputted to a CNN, that forms the filter model learning unit 103, and false defect, a size of defect, and a type of defect are identified on a pixel-by-pixel basis based on a pixel difference between the reference image and the inspection image. In the identification of the false defect, a size of defect, and a type of defect, specifically, a probability (degree of certainty) that there is an actual defect and a degree of certainty that the type of defect is, for example, a defect with “short wiring” are calculated for each pixel. In this processing, as the teacher information used in training, for example, a defect detection result that exists in a bounding box surrounding the defect site by manual annotation is set as the actual defect, and a defect detection result that exists outside the box is set as the false defect. Further, a type of defect and a size of defect are also set as teacher information at the time of annotation. In addition, not only supervised learning but also unsupervised learning may be used. Finally, in step S106, a trained filter model is stored in the filter model DB 8. As a result, false defect, a size of defect, and a type of defect can be identified using a common filter model in a plurality of processing steps. This is because the filter model (classification model) can be made common between steps where the same pattern exists. The subsequent processing flow at the time of inference by the data processing unit 10 is similar to the processing illustrated in FIG. 5 and described in the first embodiment, and the processing flow performed by the defect filter unit 105 is similar to the processing flow illustrated in FIG. 8 and described in the first embodiment. Furthermore, the processing flow of the inspection image normalization unit 101 is similar to the processing flow illustrated in FIG. 9 and described in the first embodiment.

As has been described above, according to this embodiment, the difference in inspection image due to the difference in imaging conditions can be absorbed and hence, it is possible to provide the defect inspection system and the defect inspection method that enable highly efficient inspection.

Specifically, even in a case where the deformation amount, the image quality, and the contrast change due to the difference between imaging conditions, or in a case where the optimal imaging condition changes for each processing step, the difference between the inspection images can be absorbed.

In the first embodiment and the second embodiment described above, the data processing unit 10 that forms the defect inspection system 100 is configured as a unit separate from the inspection device 3, but may be disposed in the inspection device 3. In addition, in the first embodiment and the second embodiment, the defect detection unit 104, the defect filter unit 105, and the inspection image normalization unit 101 are disposed in the computer 7. However, the present invention is not limited to such a configuration. For example, the defect filter unit 105 and the inspection image normalization unit 101 may be disposed in a different computer or a device in which the defect detection unit 104 is not disposed.

In addition, in the first embodiment and the second embodiment described above, the defect inspection system 100 for a semiconductor has been described as an example. However, the present invention is not limited to a semiconductor and is applicable to any appearance inspection device provided that the device uses an image. For example, the present invention is applicable to appearance inspection in a mass production line, such as the inspection of defective parts among parts.

The present invention is not limited to the above-described embodiments, and includes various modifications of these embodiments. For example, the above-described embodiments have been described in detail for facilitating the understanding of the present invention. However, the present invention is not necessarily limited to the defect detection system that includes all constituent elements described above. Further, a part of the configuration of one embodiment can be replaced with the configuration of another embodiment, and the configuration of another embodiment can be added to the configuration of one embodiment.

What is claimed is:

1. A defect inspection system that inspects presence or absence of a defect in a sample to be processed in one or more processing steps based on an inspection image of the sample captured after the one or more processing steps, the defect inspection system comprising:
a defect detection unit configured to detect defect positions in the inspection image by comparing the inspection image with a reference image that is an image having no defects at the same inspection point as an inspection point of the inspection image;
a filter model configured to classify the defect positions detected by the defect detection unit into false defect or a designated type of defect;
a filter condition holding unit configured to hold a filter condition formed of the designated type of defect and/or a size of defect;
a defect region extraction unit configured to extract a defect region where the defect positions detected by the defect detection unit are collected for each predetermined distance;
a defect filter unit configured to determine whether or not each defect region extracted by the defect region extraction unit satisfies the filter condition, and configured to extract only the defect region that satisfies the filter condition; and
a normalization unit configured to normalize the inspection image based on the processing step and a normalization condition set for each processing step or each imaging condition at the time of inspection, wherein
the filter model is configured to be acquired by training using the inspection image normalized by the normalization unit.

2. The defect inspection system according to claim 1, wherein the filter model is also applicable to a processing step having no learning data by setting only a normalization condition when training is performed using an inspection image normalized by the normalization unit common to a plurality of processing steps.

3. The defect inspection system according to claim 2, wherein the filter model is configured to identify presence or absence of a defect or a type of defect existing in the inspection image by machine learning using a convolution neural network (CNN).

4. The defect inspection system according to claim 2, wherein a type of defect that forms the filter condition is at least any one of a shortness of a wiring line, a short circuit of the wiring line, tapering of the wiring line, opening of the wiring line, a flaw formed on the wiring line, a foreign matter existing on the wiring line and/or in the wiring line, a defect formed on a part other than the wiring line, and a difference in contrast.

5. The defect inspection system according to claim 2, wherein the normalization unit is configured to convert the inspection image into a normalized image based on a conversion parameter for converting the inspection image into the normalized image to be used for the filter model, and the filter model is configured to be commonly used in a plurality of processing steps.

6. The defect inspection system according to claim 5, wherein the filter model is configured to classify the defect into false defect or a designated type of defect on a pixelby-pixel basis based on the inspection image.

7. The defect inspection system according to claim 6, further comprising a normalization condition database, wherein the normalization unit is configured to calculate a conversion parameter for normalization in advance for each processing step, and is configured to store the conversion parameter as the normalization condition in the normalization condition database.

8. A defect inspection method for inspecting presence or absence of a defect in a sample to be processed in one or more processing steps based on an inspection image of the sample captured after the one or more processing steps, wherein
a defect detection unit detects defect positions in the inspection image by comparing the inspection image with a reference image that is an image having no defects at the same inspection point as an inspection point of the inspection image;
a filter model classifies the defect positions detected by the defect detection unit into false defect or a designated type of defect;
a filter condition holding unit holds a filter condition formed of the designated type of defect and/or a size of defect;
a defect region extraction unit extracts a defect region where the defect positions detected by the defect detection unit are collected for each predetermined distance;
a defect filter unit determines whether or not each defect region extracted by the defect region extraction unit satisfies the filter condition, and extracts only the defect region that satisfies the filter condition; and
a normalization unit normalizes the inspection image based on the processing step and a normalization condition set for each processing step or each imaging condition at the time of inspection, and
the filter model is acquired by training using the inspection image normalized by the normalization unit.

9. The defect inspection method according to claim 8, wherein the filter model is also applicable to a processing step having no learning data by setting only a normalization condition when training is performed using an inspection image normalized by the normalization unit common to a plurality of processing steps.

10. The defect inspection method according to claim 9, wherein the filter model identifies presence or absence of a defect or a type of defect existing in the inspection image by machine learning using a convolution neural network (CNN).

11. The defect inspection method according to claim 9, wherein a type of defect that forms the filter condition is at least any one of a shortness of a wiring line, a short circuit of the wiring line, tapering of the wiring line, opening of the wiring line, a flaw formed on the wiring line, a foreign matter existing on the wiring line and/or in the wiring line, a defect formed on a part other than the wiring line, and a difference in contrast.

12. The defect inspection method according to claim 9, wherein the normalization unit converts the inspection image into a normalized image based on a conversion parameter for converting the inspection image into the normalized image to be used for the filter model, and the filter model is commonly used in a plurality of processing steps.

13. The defect inspection method according to claim 12, wherein
the filter model is configured to classify the defect into false defect or a designated type of defect on a pixelby-pixel basis based on the inspection image.

14. The defect inspection method according to claim 3, wherein the normalization unit calculates a conversion parameter for normalization in advance for each processing step, and stores the conversion parameter as the normalization condition in the normalization condition database.
